(19) United States
(12) Patent Application Publication
(10) Pub. No.: US 2026/0272057 A1
(43) Pub. Date: Sep. 17, 2026

(54) HEAT-NOT-BURN DEVICE AND HEATING CONTROL METHOD THEREFOR

(71) Applicant: SMOORE INTERNATIONAL HOLDINGS LIMITED, Grand Cayman (KY)

(72) Inventors: Kunren YIN, Shenzhen (CN); Feng LIANG, Shenzhen (CN)

(73) Assignee: SMOORE INTERNATIONAL HOLDINGS LIMITED, Grand Cayman (KY)

(21) Appl. No.: 19/680,166

(22) Filed: May 18, 2026

Related U.S. Application Data
(63) Continuation of application No. PCT/CN2024/126572, filed on Oct. 22, 2024.

(30) Foreign Application Priority Data
Nov. 17, 2023 (CN) 202311544598.6

(51) Int. Cl. A24F 40/57; A24F 40/46; A24F 40/51; A24F 40/53; A24F 40/20

(52) U.S. Cl. CPC A24F 40/57; A24F 40/46; A24F 40/51; A24F 40/53; A24F 40/20

(57) ABSTRACT

The present disclosure discloses a heat-not-burn device and a heating control method therefor. The heating control method includes: controlling, upon receiving a heating start signal, a heating assembly to heat an aerosol generating substrate from an initial temperature to a first temperature. If a puff action is not detected within a preset time, the heating assembly is controlled to a second temperature. Upon detecting that a puff action starts, the heating assembly is controlled to a third temperature. Upon detecting that the puff action ends, the heating assembly is controlled a fourth temperature. The heating assembly is a microwave heating assembly or a laser heating assembly.

### RELATED APPLICATIONS

The present application is a continuation of International Patent Application No. PCT/CN2024/126572, filed on October 22, 2024, which claims priority to Chinese Patent Application No. 202311544598.6 filed on November 17, 2023. The entire disclosure of the prior applications is hereby incorporated by reference.

### TECHNICAL FIELD

The present disclosure relates to the field of atomization, and in particular, to a heat-not-burn device and a heating control method therefor.

### BACKGROUND

A conventional heat-not-burn device generally requires a preset temperature control profile (set during production). When a user uses the heat-not-burn device, a heating assembly is controlled to heat an aerosol generating substrate according to the temperature control profile. In this way, during heating, heating is performed at a fixed temperature value in a fixed stage according to the temperature control profile regardless of whether the user puffs. Therefore, unnecessary energy waste is caused. Moreover, the temperature of a housing of the heat-not-burn device will be excessively high during continuous puffing.

### SUMMARY

### Technical Problems

The technical problems to be resolved by the present disclosure are the technical drawbacks of unnecessary energy waste existing in the related art.

### Technical Solutions

The technical solutions used in the present disclosure to resolve the technical problems thereof are: constructing a heating control method for a heat-not-burn device, where the heat-not-burn device includes a heating assembly, and the heating assembly is a microwave heating assembly or a laser heating assembly. The method includes:

a preheating step: controlling, upon receiving a heating start signal, the heating assembly to heat an aerosol generating substrate, for the temperature of the aerosol generating substrate to be raised from an initial temperature to a first temperature;

a heating step: controlling, upon detecting that a puff action starts, the heating assembly to heat the aerosol generating substrate, for the temperature of the aerosol generating substrate to be raised from a current temperature to a third temperature, where the third temperature is greater than or equal to the first temperature; and

a temperature lowering step: controlling, upon detecting that the puff action ends, the heating assembly to heat the aerosol generating substrate, for the temperature of the aerosol generating substrate to be lowered from the current temperature to a fourth temperature, where the fourth temperature is less than the third temperature.

the heating step further includes:

controlling, if a first puff action is not detected within a preset time, the heating assembly to lower the temperature from the first temperature to a second temperature, where the second temperature is less than or equal to the first temperature.

the fourth temperature is greater than or equal to the second temperature.

the heating step further includes:

determining the third temperature according to a current total number of puffs, where the third temperature is positively correlated with the current total number of puffs.

the temperature lowering step further includes:

determining the fourth temperature according to a current total number of puffs, where the fourth temperature is positively correlated with the current total number of puffs.

a difference between the fourth temperature and the third temperature is 5 to 10 degrees Celsius; and/or a difference between the second temperature and the first temperature is 5 to 10 degrees Celsius.

the heating step includes:

a temperature raising sub-step: controlling, upon detecting that the puff action starts, the heating assembly to heat the aerosol generating substrate at a first preset power for a first time period; and

a temperature control sub-step: after the first time period expires, controlling the heating assembly to heat at a second preset power for a second time period if determining that the current temperature is lower than the third temperature, or controlling the heating assembly to stop heating for a third time period if determining that the current temperature is higher than the third temperature, where the second preset power is less than the first preset power.

The present disclosure further constructs a heat-not-burn device, including:

a heating assembly configured to heat an aerosol generating substrate, where the heating assembly is a microwave heating assembly or a laser heating assembly;

a power supply configured to supply power to the heating assembly;

a puff detection assembly configured to detect whether a puff action occurs; and

a control assembly, where the control assembly is configured to perform:

a preheating step: controlling, upon receiving a heating start signal, the heating assembly to heat an aerosol generating substrate, for the temperature of the aerosol generating substrate to be raised from an initial temperature to a first temperature;

a heating step: controlling, upon detecting that a puff action starts, the heating assembly to heat the aerosol generating substrate, for the temperature of the aerosol generating substrate to be raised from a current temperature to a third temperature, where the third temperature is greater than or equal to the first temperature; and

a temperature lowering step: controlling, upon detecting that the puff action ends, the heating assembly to heat the aerosol generating substrate, for the temperature of the aerosol generating substrate to be lowered from the current temperature to a fourth temperature, where the fourth temperature is less than the third temperature.

the heating assembly is a microwave heating assembly, and the microwave heating assembly includes:

an outer conductor unit, where the outer conductor unit includes a closed end and an open end opposite to the closed end;

a receiving cavity provided in the outer conductor unit and configured to receive the aerosol generating substrate;

a microwave source unit configured to generate a microwave signal;

a microwave feed unit configured to feed the microwave signal generated by the microwave source unit; and

an inner conductor unit, where the inner conductor unit includes a microwave matching structure and a microwave radiation structure coupled to the microwave matching structure, the bottom of the microwave matching structure is connected to the closed end of the outer conductor unit and is in ohmic contact with the end wall of the closed end to form a short-circuit end of the microwave heating assembly, one end of the microwave radiation structure is coupled to the top of the microwave matching structure, and the other end of the microwave radiation structure is located in the receiving cavity to form an open-circuit end of the microwave heating assembly.

the heating assembly is a laser heating assembly, and the laser heating assembly includes:

a circuit board and a laser chip mounted on the circuit board, where the laser chip is configured to emit laser light toward the aerosol generating substrate.

the control assembly is configured in such a way that the heating step includes a temperature raising sub-step and a temperature control sub-step.

In the temperature raising sub-step, upon detecting that the puff action starts, the heating assembly is controlled to heat the aerosol generating substrate at a first preset power for a first time period.

In the temperature control sub-step, after the first time period expires, the heating assembly is continuously controlled to heat at a second preset power for a second time period if determining that the current temperature is lower than the third temperature, or the heating assembly is continuously controlled to stop heating for a third time period if determining that the current temperature is higher than the third temperature, where the second preset power is less than the first preset power.

the puff detection assembly includes:

a first air pressure sensor configured to detect whether a puff action occurs by detecting an air pressure in an air channel.

the puff detection assembly includes:

a second air pressure sensor configured to detect whether a puff action occurs by detecting an air pressure in an air channel, and detect a puff strength when the puff action occurs.

Moreover, the control assembly is further configured to:

obtain the first time period according to the puff strength, where the first time period is positively correlated with the puff strength.

### Beneficial Effects:

With the technical solutions of the present disclosure, during the heating process of a heat-not-burn device, a heating assembly performs high-power heating when a user puffs, for an aerosol generating substrate to reach a relatively high temperature (third temperature). When the user does not puff, the aerosol generating substrate is maintained at a relatively low temperature (fourth temperature). In this way, excessive carbonization of the aerosol generating substrate can be avoided, the loss is low, an excessively high housing temperature is avoided, and the energy consumption of the device can be reduced. Moreover, since the heating assembly is a microwave heating assembly or a laser heating assembly, preheating may be completed within a short time (e.g., 2 to 3 seconds). In addition, during each puff, the temperature of the aerosol generating substrate can be raised rapidly to realize rapid aerosol generation. Therefore, such a heating manner can be adapted to application scenarios where puffing is detected rapidly and responded to rapidly. Furthermore, since heating control does not need to be performed according to a preset temperature control profile, the user can puff at any puffing frequency without being restricted to finish puffing within a specific time, thereby improving the user experience.

### BRIEF DESCRIPTION OF THE DRAWINGS

To more clearly illustrate embodiments of the present disclosure, a brief introduction is given below to the accompanying drawings required for use in the description of the embodiments. It is apparent that the drawings described below are only some embodiments of the present disclosure. For those of ordinary skill in the art, other drawings can be obtained based on these drawings without creative effort. In the accompanying drawings:

FIG. 1 is a flowchart of a heating control method for a heat-not-burn device according to Example 1 of the present disclosure;

FIG. 2 is a schematic diagram of a temperature control profile according to an example of the present disclosure;

FIG. 3 is a schematic diagram of a temperature control profile according to another example of the present disclosure;

FIG. 4 is a schematic diagram of a temperature control profile and a temperature detection profile according to an example of the present disclosure;

FIG. 5 is a logic structure diagram of a heat-not-burn device according to Example 1 of the present disclosure;

FIG. 6A and FIG. 6B are structural diagrams of a heat-not-burn device according to Example 1 of the present disclosure; and

FIG. 7 is a circuit diagram of an MCU and an air pressure sensor of a heat-not-burn device according to an example of the present disclosure.

### DETAILED DESCRIPTION

The following clearly and completely describes the technical solutions in the examples of the present disclosure with reference to the accompanying drawings in the examples of the present disclosure. The described examples are some of the examples of the present disclosure rather than all of the examples. Other examples obtained by a person of ordinary skill in the art based on the disclosed examples without creative efforts shall fall within the protection scope of the present disclosure.

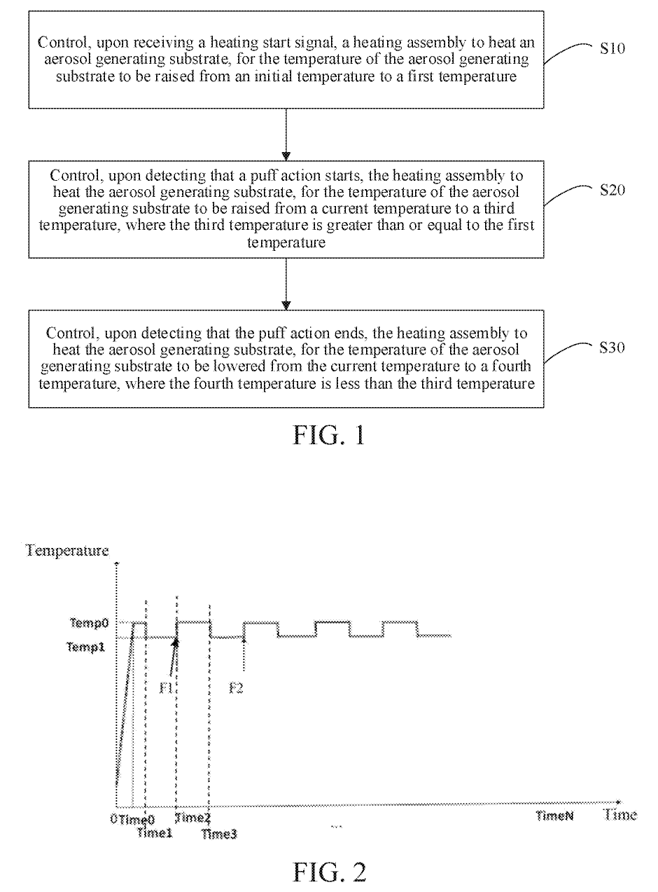

FIG. 1 is a flowchart of a heating control method for a heat-not-burn device according to Example 1 of the present disclosure. The heating control method of this example is applied to a control assembly of a heat-not-burn device. The heat-not-burn device further includes a heating assembly, a power supply, a puff detection assembly, and the like. The power supply supplies electric power to the heating assembly. The puff detection assembly is configured to detect whether a puff action occurs. The heating assembly is configured to heat an aerosol generating substrate. Moreover, the heating assembly may have various forms, for example, a heating plate, a heating pin, a heating rod, or a heating wire or filament. Alternatively, the heating assembly may be a combination of two or more different types of heating elements as described above. In addition, a positional relationship between the heating assembly and the aerosol generating substrate may have various forms. For example, the heating assembly is disposed at least partially in the center of the aerosol generating substrate, where the heating manner is central heating. The heating assembly is disposed at the end of the aerosol generating substrate, where the heating manner is end heating. The heating assembly is disposed around the aerosol generating substrate, where the heating manner is circumferential heating.

As shown in FIG. 1, the heating control method of this example includes the following steps:

Preheating step S10: Control, upon receiving a heating start signal, the heating assembly to heat an aerosol generating substrate, for the temperature of the aerosol generating substrate to be raised from an initial temperature to a first temperature.

In this step, the heating start signal may be triggered by long-pressing a button on the heat-not-burn device. Alternatively, the heating start signal may be automatically triggered when detecting that the aerosol generating substrate is inserted. Furthermore, since the heating assembly is a microwave heating assembly or a laser heating assembly, energy radiated by microwave or laser is relatively high, which can instantaneously raise the temperature of the aerosol generating substrate. For example, when a microwave heating manner is adopted, the heating assembly may raise the temperature of the aerosol generating substrate from 25°C (an initial temperature is the room temperature) to 251°C within 2.3 seconds. The average temperature rise per unit time is: (251–25)/2.3=98.26°C/s. As another example, when heating a Marlboro cigarette in which a tobacco segment has a weight of 0.28 g in a microwave heating manner, continuous heating at 20 W for 2 seconds can raise the temperature of the tobacco segment of the cigarette from the room temperature of 25°C to more than 260°C. Therefore, this heating manner can complete preheating within 2 to 3 seconds. Compared with conventional resistive or electromagnetic heating manners that require about 20 seconds to complete preheating, the preheating time is greatly shortened, the user waiting time is shortened, and the user experience is improved.

Heating step S20: Control, upon detecting that a puff action starts, the heating assembly to heat the aerosol generating substrate in a microwave or laser manner, for the temperature of the aerosol generating substrate to be raised from a current temperature to a third temperature, where the third temperature is greater than or equal to the first temperature.

In this step, a puff action of a user may be detected by the puff detection assembly. Furthermore, upon detecting that the puff action starts, the heating assembly is controlled to raise the temperature of the aerosol generating substrate from the current temperature to the third temperature. The third temperature may be equal to the first temperature. In another example, the third temperature may be greater than the first temperature.

Temperature lowering step S30: Control, upon detecting that the puff action ends, the heating assembly to heat the aerosol generating substrate in a microwave or laser manner, for the temperature of the aerosol generating substrate to be lowered from the current temperature to a fourth temperature, where the fourth temperature is less than the third temperature. a difference between the fourth temperature and the third temperature is 5 to 10 degrees Celsius.

In this step, upon detecting that the puff action ends, the temperature of the aerosol generating substrate is lowered from the current temperature to the fourth temperature by controlling the heating assembly. In an example, upon detecting that the puff action ends, heating of the heating assembly may be stopped first, so that the temperature of the aerosol generating substrate is lowered rapidly. When the temperature is lowered to the fourth temperature, the heating assembly is controlled to heat the aerosol generating substrate again, so as to maintain the aerosol generating substrate at the fourth temperature. In another example, upon detecting that the puff action ends, the temperature of the aerosol generating substrate may be slowly lowered to the fourth temperature by gradually reducing the power of the heating assembly.

In this example, during the preheating stage, the temperature of the aerosol generating substrate is first raised from the initial temperature to the first temperature by controlling the heating assembly. During the heating stage, upon detecting that the puff action starts, the temperature of the aerosol generating substrate is raised from the current temperature to the third temperature (the third temperature is greater than or equal to the first temperature) by controlling the heating assembly. Upon detecting that the puff action ends, the temperature of the aerosol generating substrate is lowered from the current temperature to the fourth temperature (the fourth temperature is less than or equal to the third temperature) by controlling the heating assembly. In other words, during the heating process of a heat-not-burn device, a heating assembly performs high-power heating only when a user puffs, for an aerosol generating substrate to reach a relatively high temperature (third temperature). When the user does not puff, the aerosol generating substrate is maintained at a relatively low temperature (fourth temperature). In this way, excessive carbonization of the aerosol generating substrate can be avoided, the loss is low, an excessively high housing temperature is avoided, and the energy consumption of the device can be reduced. Moreover, since the heating assembly is a microwave heating assembly or a laser heating assembly, preheating may be completed within a short time (e.g., 2 to 3 seconds). In addition, during each puff, the temperature of the aerosol generating substrate can be raised rapidly to realize rapid aerosol generation. Therefore, such a heating manner can be adapted to application scenarios where puffing is detected rapidly and responded to rapidly. Furthermore, since heating control does not need to be performed according to a preset temperature control profile, the user can puff at any puffing frequency without being restricted to finish puffing within a specific time, thereby improving the user experience.

Further, the heating step S20 further includes:

controlling, if a first puff action is not detected within a preset time, the heating assembly to lower the temperature from the first temperature to a second temperature, where the second temperature is less than or equal to the first temperature.

In this example, since the efficiency of a microwave or laser generator is relatively low (e.g., lower than 90%), if a user does not start puffing in time after heating to the first temperature during the preheating stage, the aerosol generating substrate, maintained at such a relatively high temperature, will be consumed excessively rapidly, and the energy consumption of the heat-not-burn device will also be excessively high, resulting in problems such as heating of a housing, thereby affecting the user experience. Therefore, after reaching the first temperature, the heating assembly is controlled to heat the aerosol generating substrate, for the temperature of the aerosol generating substrate to be lowered from the first temperature to the second temperature until the user puffs for the first time.

Further, a difference between the second temperature and the first temperature is 5 to 10 degrees Celsius; and/or, the difference between the fourth temperature and the third temperature is 5 to 10 degrees Celsius. In this example, compared with the resistive heating or electromagnetic heating manner, the microwave or laser heating manner also has low thermal inertia, so that the temperature of the aerosol generating substrate will be lowered rapidly once the energy inputted from microwaves or lasers stops. To maintain the tobacco at a relatively high temperature without excessive energy consumption, the second temperature may be set to a value slightly lower than the first temperature. The difference therebetween is preferably 5 to 10 degrees Celsius. For example, the first temperature is 315 degrees Celsius, and the second temperature is 305 degrees Celsius. Similarly, the fourth temperature may be set to a value slightly lower than the third temperature. The difference therebetween is preferably 5 to 10 degrees Celsius. For example, the third temperature is 315 degrees Celsius, and the fourth temperature is 305 degrees Celsius.

Further, the fourth temperature is greater than or equal to the second temperature.

Further, the first temperature is equal to the third temperature, and the second temperature is equal to the fourth temperature.

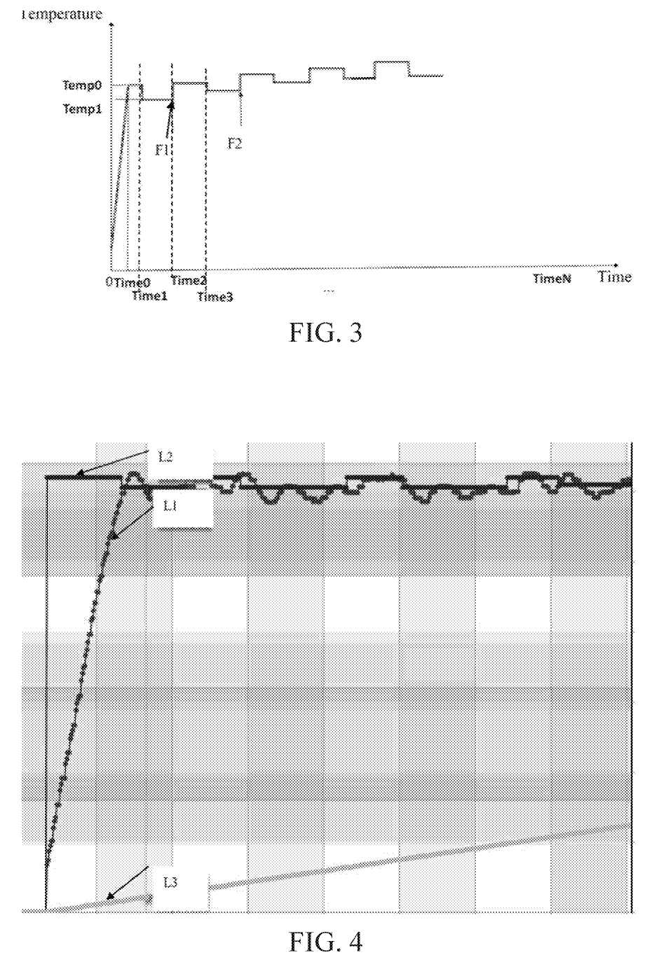

In an aspect, as shown in FIG. 2, the first temperature and the third temperature are 315 degrees Celsius, respectively, and the second temperature and the fourth temperature are 305 degrees Celsius, respectively. With reference to FIG. 2, after receiving a heating start signal, the temperature of the aerosol generating substrate is raised from the room temperature to a first temperature (315 degrees Celsius) during the period from 0 to time0 (e.g., 2 s), and maintained for a period of time (from time0 to time1). For example, the temperature is maintained for 1 s. To be specific, if a first puff action is not detected within a preset time (e.g., 1 s) after reaching the first temperature, the temperature is lowered from the first temperature to a second temperature (305 degrees Celsius) at time1 and maintained thereat until a first puff action F1 is detected at time2. At time2, the temperature of the aerosol generating substrate is raised again to a third temperature (315 degrees Celsius) until the end of the puff action is detected at time3. At time3, the temperature of the aerosol generating substrate is lowered from the third temperature (315 degrees Celsius) to a fourth temperature (305 degrees Celsius) until a second puff action F2 is detected, and the process repeats in this manner.

Further, the heating step S20 further includes:

determining the third temperature according to a current total number of puffs, where the third temperature is positively correlated with the current total number of puffs.

Additionally or alternatively, the temperature lowering step S30 further includes:

determining the fourth temperature according to a current total number of puffs, where the fourth temperature is positively correlated with the current total number of puffs.

In this example, the third temperature and the fourth temperature corresponding to each puff are different from each other, and increase as the total number of puffs increases.

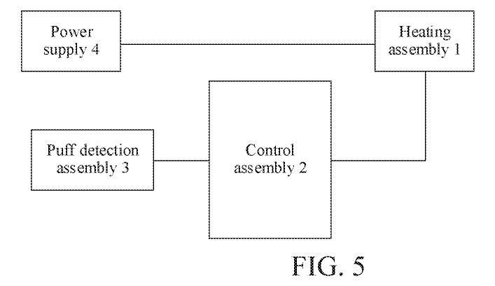

In an example, as shown in FIG. 3, the first temperature is 315 degrees Celsius, and the second temperature is 305 degrees Celsius. The third temperature corresponding to the first puff is 317 degrees Celsius, and the fourth temperature corresponding to the first puff is 307 degrees Celsius. The third temperature corresponding to the second puff is 319 degrees Celsius, and the fourth temperature corresponding to the second puff is 309 degrees Celsius, and so on. With reference to FIG. 3, after receiving a heating start signal, the temperature of the aerosol generating substrate is raised from the room temperature to a first temperature (315 degrees Celsius) during the period from 0 to time0 (e.g., 2 s), and maintained for a period of time (from time0 to time1). For example, the temperature is maintained for 1 s. To be specific, if a first puff action is not detected within a preset time (e.g., 1 s) after reaching the first temperature, the temperature is lowered from the first temperature to a second temperature (305 degrees Celsius) at time1 and maintained thereat until a first puff action F1 is detected at time2. At time2, the temperature of the aerosol generating substrate is raised to the third temperature (317 degrees Celsius) corresponding to the first puff, until the end of the first puff action is detected at time3. At time3, the temperature of the aerosol generating substrate is lowered from the third temperature (317 degrees Celsius) to the fourth temperature (307 degrees Celsius) corresponding to the first puff, until the second puff action F2 is detected, and the process repeats in this manner.

Certainly, in other examples, each puff corresponds to a third temperature and a fourth temperature during the entire puffing process. Therefore, a plurality of third temperatures and a plurality of fourth temperatures are correspondingly provided during the entire puffing process. Moreover, the third temperature corresponding to each puff may be independent of the current total number of puffs, and correspondingly, the fourth temperature corresponding to each puff may be independent of the current total number of puffs. In other words, among the plurality of third temperatures during the entire puffing process, the temperature values of at least some of the third temperatures are equal to the first temperature, and the temperature values of the remaining third temperatures are higher than the first temperature. Correspondingly, among the plurality of fourth temperatures during the entire puffing process, the temperature values of at least some of the fourth temperatures are equal to the second temperature, and the temperature values of the remaining fourth temperatures are higher than the second temperature. For example, the user performs thirteen puffs during the entire puffing process. The third temperatures corresponding to the first to thirteenth puffs are respectively: 315 degrees Celsius, 317 degrees Celsius, 319 degrees Celsius, 321 degrees Celsius, 319 degrees Celsius, 317 degrees Celsius, 315 degrees Celsius, 317 degrees Celsius, 319 degrees Celsius, 321 degrees Celsius, 319 degrees Celsius, 317 degrees Celsius, and 315 degrees Celsius. The third temperatures corresponding to the first to thirteenth puffs are respectively: 305 degrees Celsius, 307 degrees Celsius, 309 degrees Celsius, 321 degrees Celsius, 309 degrees Celsius, 307 degrees Celsius, 305 degrees Celsius, 307 degrees Celsius, 309 degrees Celsius, 321 degrees Celsius, 309 degrees Celsius, 307 degrees Celsius, and 305 degrees Celsius.

Further, the heat-not-burn assembly further includes a temperature detection assembly. It should be noted that the temperature detection assembly actually detects the temperature of the heating assembly, preferably the temperature of the outer wall of the heating assembly. The heating temperature of the aerosol generating substrate is controlled by controlling the temperature of the heating assembly. The temperature of the heating assembly is positively correlated with that of the aerosol generating substrate, but not necessarily completely identical thereto. In other words, the temperature of the heating assembly may be used to represent the temperature of the aerosol generating substrate. Moreover, the heating step S20 includes:

a temperature raising sub-step: controlling, upon detecting that the puff action starts, the heating assembly to heat the aerosol generating substrate at a first preset power for a first time period; and

a temperature control sub-step: controlling, after the first time period expires, the heating assembly to heat at a second preset power for a second time period if determining that the current temperature is lower than the third temperature, or controlling the heating assembly to stop heating for a third time period if determining that the current temperature is higher than the third temperature, where the second preset power is less than the first preset power. The second time period and the third time period are preferably the same, but may alternatively be different. In addition, it should be noted that the remaining time of the duration of a single puff action (e.g., 1 to 2 s) after deducting the constant-power heating time (the first time period, e.g., 350 ms) is much longer than the temperature detection cycle (e.g., 20 to 30 ms). Therefore, temperature judgment and power adjustment may be performed repeatedly and cyclically in the temperature control sub-step. For example, if the duration of a single puff action of a user is 1 s, the first time period is 350 ms, the corresponding remaining time is 650 ms, and the temperature detection cycle is 30 ms, then approximately 22 cycles of temperature judgment and power adjustment will be performed in the temperature control sub-step.

In this example, when the control assembly controls the heating assembly, heating is performed at a constant power (first preset power) for a first time period, followed by cyclical temperature judgment and power adjustment. Compared with the conventional PID control scheme, the control scheme of this example can reduce the noise of the heat-not-burn device. This is because a differentiator in the PID control scheme is sensitive to high-frequency signals generated by the microwave heating assembly or laser heating assembly and tends to amplify noise signals.

In an aspect, the first time period is, for example, 350 ms, the second time period and the third time period are, for example, 30 ms respectively, the first preset power may be a maximum output power, for example, 20 W, and the second preset power is, for example, 10 W. In this way, upon detecting that the puff action starts, the heating assembly is first controlled to heat at a constant power of 20 W for 350 ms, so that the temperature of the aerosol generating substrate is raised. Then, the temperature is detected every 30 ms. If the current temperature is lower than the third temperature (puff temperature), the heating assembly is controlled to heat at a constant power of 10 W for 30 ms. If the current temperature is higher than the third temperature, heating is stopped for 30 ms. Temperature detection and power adjustment are repeated cyclically in this manner until the end of the puff action is detected.

In an aspect, the first time period is, for example, 450 ms, the second time period is, for example, 30 ms, the third time period is, for example, 20 ms, the first preset power may be a maximum output power, for example, 20 W, and the second preset power is, for example, 10 W. In this way, upon detecting that the puff action starts, the heating assembly is first controlled to heat at a constant power of 20 W for 450 ms, so that the temperature of the aerosol generating substrate is raised. Then, temperature detection starts. If the current temperature is lower than the third temperature (puff temperature), the heating assembly is controlled to heat at a constant power of 10 W for 30 ms. If the current temperature is higher than the third temperature, heating is stopped for 20 ms. Temperature detection and power adjustment are repeated cyclically in this manner until the end of the puff action is detected.

In an aspect, as shown in FIG. 4, profile L3 is a power profile outputted to the heating assembly, profile L1 is a temperature detection profile obtained by the temperature detection assembly, and profile L2 is a set temperature target profile (i.e., temperature control profile). Moreover, the temperature target profile L2 is not pre-provided in a processor of the heat-not-burn device, but is a profile related to an actual puff frequency of the user. Therefore, for the same heat-not-burn device, the temperature target profiles corresponding to the puffs of the user at different puff frequencies at different moments may be different. As shown in FIG. 4, during the heating control process, the temperature detection profile L1 may approach the temperature target profile through the temperature raising sub-step and the temperature control sub-step.

Further, the heating control method of the present disclosure further includes: outputting a reminder message when the temperature of the aerosol generating substrate is raised from the initial temperature to the first temperature. For example, the reminder message may be outputted by means of sound, light, vibration, or the like. In this embodiment, a reminder message may be outputted when the aerosol generating substrate reaches the first temperature, so as to remind the user that the preparation in the preheating stage is completed and puffing may be performed.

Further, the heating control method of the present disclosure further includes:

stopping heating control on the heating assembly when determining that a preset stop condition is met, where the preset stop condition includes at least one of the following:

a total number of puffs reaches a preset number, where the preset number is, for example, 10 to 16;

an accumulated heating time reaches a preset time, where the preset time is, for example, 4 to 60 minutes; and

a stop instruction inputted by a user is received.

In this example, the heating control on the heating assembly may be stopped when the total number of puffs reaches a set number, the entire puffing time exceeds a predetermined time, or a user inputs a stop instruction (e.g., long-pressing a body button).

FIG. 5 is a logic structure diagram of a heat-not-burn device according to Example 1 of the present disclosure. The heat-not-burn device of this example includes a heating assembly 1, a control assembly 2, a puff detection assembly 3, and a power supply 4. The heating assembly 1 is configured to heat an aerosol generating substrate, and the heating assembly 1 may be a microwave heating assembly or a laser heating assembly. The power supply 4 is configured to supply power to the heating assembly 1. The puff detection assembly 3 is configured to detect whether a puff action occurs. The control assembly 2 is configured to perform:

a preheating step: controlling, upon receiving a heating start signal, the heating assembly to heat an aerosol generating substrate, for the temperature of the aerosol generating substrate to be raised from an initial temperature to a first temperature;

a heating step: controlling, upon detecting that a puff action starts, the heating assembly to heat the aerosol generating substrate, for the temperature of the aerosol generating substrate to be raised from a current temperature to a third temperature, where the third temperature is greater than or equal to the first temperature; and

a temperature lowering step: controlling, upon detecting that the puff action ends, the heating assembly to heat the aerosol generating substrate, for the temperature of the aerosol generating substrate to be lowered from the current temperature to a fourth temperature, where the fourth temperature is less than the third temperature.

Further, the control assembly is configured to: control, if a first puff action is not detected within a preset time in the heating step, the heating assembly to lower the temperature from the first temperature to a second temperature, where the second temperature is less than or equal to the first temperature.

Further, the control assembly is configured in such a way that the fourth temperature is greater than or equal to the second temperature.

Further, the control assembly is configured in such a way that a difference between the fourth temperature and the third temperature is 5 to 10 degrees Celsius; and/or a difference between the second temperature and the first temperature is 5 to 10 degrees Celsius.

Further, the control assembly is configured to: determine, in the heating step, the third temperature according to a current total number of puffs, where the third temperature is positively correlated with the current total number of puffs; and determine, in the temperature lowering step, the fourth temperature according to the current total number of puffs, where the fourth temperature is positively correlated with the current total number of puffs.

Further, the control assembly is configured in such a way that the heating step includes a temperature raising sub-step and a temperature control sub-step.

In the temperature raising sub-step, upon detecting that the puff action starts, the heating assembly is controlled to heat the aerosol generating substrate at a first preset power for a first time period.

In the temperature control sub-step, after the first time period expires, the heating assembly is continuously controlled to heat at a second preset power for a second time period if determining that the current temperature is lower than the third temperature, or the heating assembly is continuously controlled to stop heating for a third time period if determining that the current temperature is higher than the third temperature, where the second preset power is less than the first preset power. The second time period and the third time period may be the same, or may be different. In addition, it should be noted that the remaining time of the duration of a single puff action (e.g., 1 to 2 s) after deducting the constant-power heating time (the first time period, e.g., 350 ms) is much longer than the temperature detection cycle (e.g., 20 to 30 ms). Therefore, temperature judgment and power adjustment may be performed repeatedly and cyclically in the temperature control sub-step. For example, if the duration of a single puff action of a user is 1 s, the first time period is 350 ms, the corresponding remaining time is 650 ms, and the temperature detection cycle is 30 ms, then approximately 22 cycles of temperature judgment and power adjustment will be performed in the temperature control sub-step.

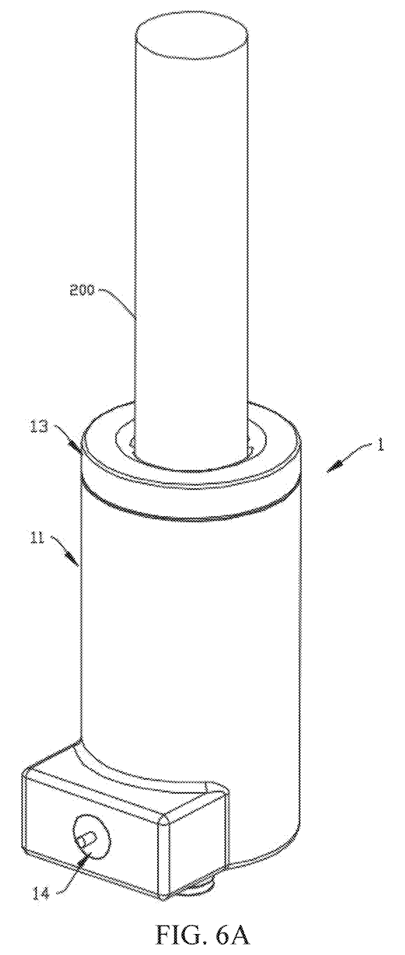

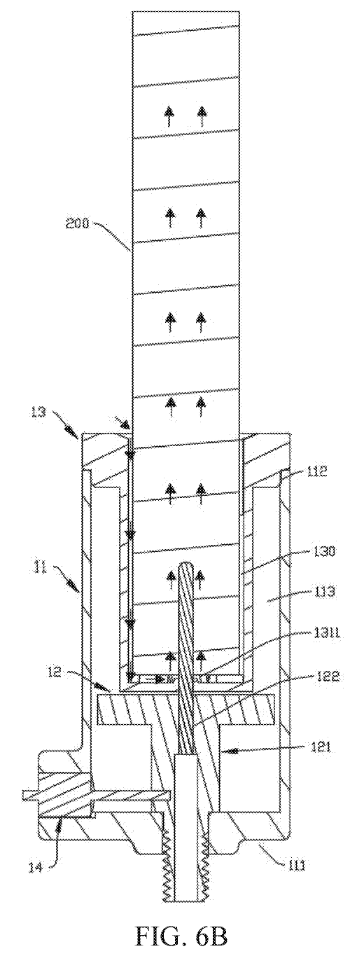

In this example, when the control assembly controls the heating assembly, heating is performed at a constant power (first preset power) for a first time period, followed by cyclical temperature judgment and power adjustment. Compared with the conventional PID control scheme, the control scheme of this example can reduce the noise of the heat-not-burn device. This is because a differentiator in the PID control scheme is sensitive to high-frequency signals generated by the microwave heating assembly or laser heating assembly and tends to amplify noise signals. Further, the heating assembly 1 is a microwave heating assembly. With reference to FIG. 6A and FIG. 6B, in the microwave heating assembly 1 of this example, a microwave field acting on an aerosol generating substrate 200 is formed in a cavity 113 thereof, so as to achieve microwave heating. The aerosol generating substrate 200 is a solid aerosol generating substrate such as treated plant leaf products. It may be understood that in some other examples, the aerosol generating substrate 200 may be a liquid aerosol generating substrate.

As shown in FIG. 6A, in some examples, the overall shape of the microwave heating assembly 1 is substantially in a cylindrical shape. Certainly, the microwave heating assembly 1 is not limited to being in a cylindrical shape, and may alternatively be in another shape such as a square cylindrical shape or an elliptical cylindrical shape. With reference to FIG. 6B, the microwave heating assembly 1 may include an outer conductor unit 11, an inner conductor unit 12, a receiving base 13, a microwave source unit (not shown), and a microwave feed unit 14.

The outer conductor unit 11 has a closed end 111 and an open end 112 opposite to the closed end 111, and may define a semi-closed cavity 113. The inner wall surface of the cavity 113 is conductively disposed. The inner conductor unit 12 includes a microwave matching structure 121 and a microwave radiation structure 122 coupled to the microwave matching structure 121. The bottom of the microwave matching structure 121 is connected to the closed end 111 of the outer conductor unit 11 and is in ohmic contact with the end wall of the closed end 111 to form a short-circuit end of the microwave heating assembly 1. One end of the microwave radiation structure 122 is coupled to the top of the microwave matching structure 121, and the other end of the microwave radiation structure 122 is located in the cavity 113 but not in direct contact with the outer conductor unit 11, to form an open-circuit end of the microwave heating assembly 1. The microwave feed unit 14 is detachably mounted on the outer conductor unit 11 for feeding microwaves generated by the microwave source unit into the cavity 113. The receiving base 13 is fixedly or detachably mounted at the open end 112 of the outer conductor unit 11, and defines a receiving cavity 130 for receiving the aerosol generating substrate 200. The end of the microwave radiation structure 122 away from the microwave matching structure 121 extends and is inserted into the receiving cavity 130. The receiving base 13 may include a receiving portion and a fixing portion integrally connected to the receiving portion. The receiving portion may be cylindrical with the outer diameter smaller than the inner diameter of the outer conductor unit 11, is mounted in the cavity 113, and defines an axial receiving cavity 130 for receiving the aerosol generating substrate 200. Moreover, the bottom of the receiving portion is designed to be closed and has a bottom wall surface 1311 for supporting the aerosol generating substrate 200.

It is understandable that the aerosol generating substrate 200 may be partially or fully inserted into the receiving cavity 130. At this time, part of the structure of the microwave radiation structure 122 is inserted inside the aerosol generating substrate 200. When the microwave source unit feeds microwaves through the microwave feed unit 14, a microwave energy field may be formed around the microwave radiation structure 122 to heat the interior of the aerosol generating substrate 200. In conjunction with a puff action of a user to drive airflow, an aerosol formed by mixing air with a medium generated after heating may enter the oral cavity of the user along the airflow direction.

Further, to control the distribution of the microwave energy field so that the distribution of the microwave energy field to the aerosol generating substrate is more biased toward the bottom of the aerosol generating substrate, the microwave heating assembly further includes a microwave field adjusting structure (not shown) disposed in the cavity 113. The microwave field adjusting structure is integrally coupled to the inner peripheral side wall of the outer conductor unit 11 or in ohmic contact with the inner peripheral side wall of the outer conductor unit 11. The microwave field adjusting structure surrounds the periphery of the receiving cavity 130 and the microwave field adjusting structure includes a top wall facing the open end 112. The top wall is closer to the closed end 111 than a first free end. In other words, the top of the microwave field adjusting structure 15 is lower in height than the end of the microwave radiation structure 122 adjacent to the open end 112.

Further, the heating assembly is a laser heating assembly, and the laser heating assembly includes a circuit board and a laser chip mounted on the circuit board, where the laser chip is configured to emit laser light toward the aerosol generating substrate.

Further, the heat-not-burn device of the present disclosure may further include a rotating assembly. The rotating assembly is configured to drive at least one of the aerosol generating substrate and the heating assembly to rotate, so as to adjust a laser irradiation region of the heating assembly on the aerosol generating substrate.

Further, the puff detection assembly includes a first air pressure sensor. The first air pressure sensor is a first air pressure sensor configured to detect whether a puff action occurs by detecting an air pressure in an air channel.

Further, the puff detection assembly includes a second air pressure sensor. The second air pressure sensor is configured to detect whether a puff action occurs by detecting an air pressure in an air channel, and detect a puff strength when the puff action occurs. Moreover, the control assembly is further configured to: obtain the first time period according to the puff strength, where the first time period is positively correlated with the puff strength. For example, in a specific example, if the puff strength of the current puff is less than a preset value, the heating assembly is controlled to continuously heat the aerosol generating substrate at a first preset power (e.g., 20 W) for 350 ms in the temperature raising sub-step. If the puff strength of the current puff is greater than or equal to the preset value, the heating assembly is controlled to continuously heat the aerosol generating substrate at the first preset power (e.g., 20 W) for 550 ms.

In the foregoing example, the first air pressure sensor or the second air pressure sensor may be mounted inside the cavity or on the outer surface of the cavity, so as to detect air pressure changes in the air channel during aerosol generation of the heat-not-burn device. After preheating, the heat-not-burn device dynamically adjusts the temperature control profile during aerosol generation by detecting the puff action of the user as the user puffs.

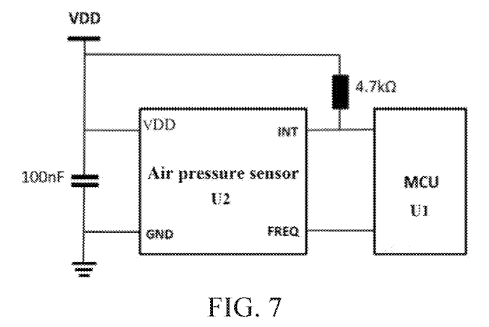

In an aspect, as shown in FIG. 7, the control assembly is an MCU U1. A trigger interrupt pin (INT) of an air pressure sensor U2 is connected to a first pin of the MCU U1, and a frequency output pin (FREQ) of the air pressure sensor U2 is connected to a second pin of the MCU U1. In addition, the trigger interrupt pin of the air pressure sensor U2 is further connected to a power supply voltage via a resistor. A power supply pin (VDD) of the air pressure sensor U2 is also connected to the power supply voltage. A ground pin (GND) of the air pressure sensor U2 is grounded, and a capacitor is further connected between the power supply pin and the ground pin of the air pressure sensor U2.

A trigger pressure threshold of the air pressure sensor U2 may be set at the factory, for example, 200 Pa. During use, if the user puffs, the air pressure in the air channel will change. The air pressure sensor U2 detects the air pressure change and then outputs a corresponding interrupt trigger signal and frequency signal. The MCU U1 may determine whether the user has puffed by detecting the signals. Specifically, when the air pressure sensor U2 detects a pressure greater than or equal to 200 Pa, the trigger interrupt pin thereof outputs a high level; otherwise, the pin maintains a low level. In this way, the MCU U1 may determine whether a puff action has occurred according to the high or low level of the first pin thereof. Moreover, after the trigger pressure threshold is reached, the frequency output pin of the air pressure sensor U2 outputs a reference frequency (e.g., 2 KHz). Thereafter, each time the pressure is increased by 200 Pa, the frequency outputted from the frequency output pin is increased by a specific percentage, for example, by 3%. In this way, the MCU U1 may determine the puff strength of the user according to the frequency signal inputted by the second pin thereof.

When the MCU U1 controls the heating assembly according to whether a puff action has occurred, the output power of the heating assembly is adjusted to bring the aerosol generating substrate to a corresponding temperature target value regardless of whether the user puffs. Moreover, since the heating assembly adopts a microwave or laser heating manner, a relatively large power is outputted rapidly when the user puffs, so that the temperature of the aerosol generating substrate is raised rapidly to meet the demand of the user for aerosol during puffing. When the user does not puff, the temperature is lowered by 5 to 10 degrees Celsius, to reduce power consumption of the device.

The foregoing descriptions are merely examples of the present disclosure, but are not intended to limit the present disclosure. A person skilled in the art may make various alterations and variations to the present disclosure. Any modification, equivalent replacement, and improvement made within the spirit and principle of the present disclosure are required to fall within the scope of the claims of the present disclosure.

1. A heating control method for a heat-not-burn device comprising:
controlling, upon receiving a heating start signal, a heating assembly of the heat-not-burn device from an initial temperature to a first temperature;
if a puff action is not detected within a preset time,
controlling the heating assembly to a second temperature;
if the puff action is detected within the preset time,
controlling the heating assembly to heat an aerosol generating substrate to a third temperature; and
controlling, upon detecting that the puff action ends, the heating assembly to a fourth temperature, wherein the heating assembly is a microwave heating assembly or a laser heating assembly.

2. The heating control method of claim 1, wherein
the second temperature is less than the first temperature; and
the third temperature is greater than or equal to the first temperature.

3. The heating control method of claim 2, wherein the fourth temperature is greater than or equal to the second temperature, and less than the third temperature.

4. The heating control method of claim 1, further comprising:
determining the third temperature according to an accumulated number of puffs, wherein the third temperature is positively correlated with the accumulated number of puffs.

5. The heating control method of claim 1, further comprising:
determining the fourth temperature according to an accumulated number of puffs, wherein the fourth temperature is positively correlated with the accumulated number of puffs.

6. The heating control method of claim 3, wherein
a difference between the fourth temperature and the third temperature is 5 to 10 degrees Celsius; and/or
a difference between the second temperature and the first temperature is 5 to 10 degrees Celsius.

7. The heating control method of claim 1, wherein if the puff action is detected further comprises:
controlling, upon detecting that the puff action starts, the heating assembly to heat the aerosol generating substrate at a first preset power for a first time period; and
after the first time period expires,
controlling the heating assembly to heat at a second preset power for a second time period if determining that the current temperature is lower than the third temperature, or
controlling the heating assembly to stop heating for a third time period if determining that the current temperature is higher than the third temperature.

8. A heat-not-burn device comprising:
a heating assembly being configured to heat an aerosol generating substrate, wherein the heating assembly is a microwave heating assembly or a laser heating assembly;
a power supply supplying power to the heating assembly;
a puff detection assembly detecting whether a puff action occurs; and
a control assembly controlling, upon receiving a heating start signal, the heating assembly to heat an aerosol generating substrate from an initial temperature to a first temperature;
if the puff action is detected within the preset time,
the control assembly controlling to heat the aerosol generating substrate to a third temperature; and
the control assembly controlling, upon detecting that the puff action ends, the heating assembly to a fourth temperature.

9. The heat-not-burn device of claim 8, wherein the microwave heating assembly comprises:
an outer conductor unit includes a closed end, an open end opposite to the closed end, and a receiving cavity is configured to receive the aerosol generating substrate;
a microwave source unit is configured to generate a microwave signal;
a microwave feed unit is configured to feed the microwave signal;
an inner conductor unit comprises a microwave matching structure and a microwave radiation structure coupled to the microwave matching structure;
a bottom of the microwave matching structure is connected to the closed end of the outer conductor unit and is in ohmic contact with the end wall of the closed end to form a short-circuit end of the microwave heating assembly; and
one end of the microwave radiation structure is coupled to a top of the microwave matching structure, and another end of the microwave radiation structure is located in the receiving cavity to form an open-circuit end of the microwave heating assembly.

10. The heat-not-burn device of claim 8, wherein the laser heating assembly comprises:
a laser chip configured to emit laser light toward the aerosol generating substrate.

11. The heat-not-burn device of claim 8, wherein
upon detecting that the puff action starts, the heating assembly is controlled to heat the aerosol generating substrate at a first preset power for a first time period; and
after the first time period expires,
the heating assembly is controlled to heat at a second preset power for a second time period if a current temperature is lower than the third temperature, or
the heating assembly is controlled to stop heating for a third time period if the current temperature is higher than the third temperature, wherein the second preset power is less than the first preset power.

12. The heat-not-burn device of claim 8, wherein the puff detection assembly comprises:
a first air pressure sensor configured to detect whether a puff action occurs by detecting an air pressure in an air channel.

13. The heat-not-burn device of claim 11, wherein
the puff detection assembly comprises:
a second air pressure sensor configured to detect whether a puff action occurs by detecting an air pressure in an air channel, and detect a puff strength when the puff action occurs; and
the control assembly is further configured to:
obtain the first time period according to the puff strength, wherein the first time period is positively correlated with the puff strength.
